(19) United States
(12) Patent Application Publication
(10) Pub. No.: US 2025/0378134 A1
(43) Pub. Date: Dec. 11, 2025

(54) DATA PROCESSING CHIP, AND DATA PROCESSING METHOD AND DEVICE

(71) Applicant: Smarter Silicon (Shanghai) Technologies Co., Ltd., Shanghai (CN)

(72) Inventor: Yong CHEN, Shanghai (CN)

(21) Appl. No.: 19/228,707

(22) Filed: Jun. 4, 2025

(30) Foreign Application Priority Data
Jun. 7, 2024 (CN) 202410741643.5

(51) Int. Cl. G06F 17/16

(52) U.S. Cl. CPC G06F 17/16

(57) ABSTRACT

A data processing chip includes hardware processing channels configured to obtain a first target data set formed by one or more pieces of first target data included in at least one first target data sub-object, obtain one or more pieces of second data included in a second data object corresponding to the target data processing channel, perform matching on the one or more pieces of first target data and the one or more pieces of second data according to first position information corresponding to each piece of first target data and second position information corresponding to each piece of second data to obtain matched data that includes one or more pieces of first target data and one or more pieces of second data that matching each other, and perform data processing on the matched data.

### CROSS-REFERENCE TO RELATED APPLICATION

This application claims priority to Chinese Patent Application No. 202410741643.5, filed on Jun. 7, 2024, the entire content of which is incorporated herein by reference.

### TECHNICAL FIELD

The present disclosure generally relates to the field of artificial intelligence technologies and, more particularly, to a data processing chip, and a data processing method and device.

### BACKGROUND

In a neural network model, weights of network layers are often quantized and pruned, resulting in a large number of zero values in a weight matrix. Also, because of a ReLU (activation) operation, a feature map will generate a large number of zero values. For example, there are a large number of zero values in the weight matrix and the feature map shown in FIG. 1 (where gray blocks represent non-zero values and white blocks represent zero values). This phenomenon of a large number of zero values in the network is called sparsification. In particular, in a Transformer network, because of local correlation of tokens (a token is a minimum unit with independent semantics, and, each token represents an independent unit, has a certain semantic meaning, and can be processed by the model), zero values (sparseness) are more common.

Because of the sparsification of data in neural networks, in data processing based on neural networks such as Transformer networks, there are problems such as low computing performance, high resource requirements such as storage and transmission, and low resource utilization. How to solve at least some of these problems has become a technical difficulty in this field.

### SUMMARY

In accordance with the disclosure, there is provided a data processing chip including a plurality of hardware processing channels configured to obtain a first target data set formed by one or more pieces of first target data included in at least one first target data sub-object. The one or more pieces of first target data at least include all valid data of one or more first data sub-objects in a first data object corresponding to a target data processing channel. The plurality of hardware processing channels are further configured to obtain one or more pieces of second data included in a second data object corresponding to the target data processing channel, perform matching on the one or more pieces of first target data and the one or more pieces of second data according to first position information corresponding to each of the one or more pieces of first target data and second position information corresponding to each of the one or more pieces of second data to obtain matched data that includes one or more of the one or more pieces of first target data and one or more of the one or more pieces of second data that matching each other, and perform data processing on the matched data. The first position information corresponding to one piece of first target data indicates a position of the one piece of first target data in the first data object, and the second position information corresponding to one piece of second data indicates a position of the one piece of second data in the second data object. The valid data included in each of the one or more first data sub-objects is located in a same one of the at least one first target data sub-object. A number of the at least one first target data sub-object is less than a number of the one or more first data sub-objects.

Also in accordance with the disclosure, there is provided a data processing method including obtaining a first target data set formed by one or more pieces of first target data included in at least one first target data sub-object. The one or more pieces of first target data at least include all valid data of one or more first data sub-objects in a first data object corresponding to a target data processing channel. The method further includes obtaining one or more pieces of second data included in a second data object corresponding to the target data processing channel, performing matching on the one or more pieces of first target data and the one or more pieces of second data according to first position information corresponding to each of the one or more pieces of first target data and second position information corresponding to each of the one or more pieces of second data to obtain matched data that includes one or more of the one or more pieces of first target data and one or more of the one or more pieces of second data that matching each other, and performing data processing on the matched data. The first position information corresponding to one piece of first target data indicates a position of the one piece of first target data in the first data object, and the second position information corresponding to one piece of second data indicates a position of the one piece of second data in the second data object. The valid data included in each of the one or more first data sub-objects is located in a same one of the at least one first target data sub-object. A number of the at least one first target data sub-object is less than a number of the one or more first data sub-objects.

Also in accordance with the disclosure, there is provided non-transitory computer-readable storage medium storing instructions that, when executed by a processor, cause the processor to obtain a first target data set formed by one or more pieces of first target data included in at least one first target data sub-object. The one or more pieces of first target data at least include all valid data of one or more first data sub-objects in a first data object corresponding to a target data processing channel. The instructions, when executed by the processor, further cause the processor to obtain one or more pieces of second data included in a second data object corresponding to the target data processing channel, perform matching on the one or more pieces of first target data and the one or more pieces of second data according to first position information corresponding to each of the one or more pieces of first target data and second position information corresponding to each of the one or more pieces of second data to obtain matched data that includes one or more of the one or more pieces of first target data and one or more of the one or more pieces of second data that matching each other, and perform data processing on the matched data. The first position information corresponding to one piece of first target data indicates a position of the one piece of first target data in the first data object, and the second position information corresponding to one piece of second data indicates a position of the one piece of second data in the second data object. The valid data included in each of the one or more first data sub-objects is located in a same one of the at least one first target data sub-object. A number of the at least one first target data sub-object is less than a number of the one or more first data sub-objects.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work.

FIG. 1 is a schematic diagram showing a sparse weight matrix and a sparse feature map consistent with embodiments of the present disclosure

FIG. 2 is a flow chart of a data processing method consistent with embodiments of the present disclosure.

FIG. 3 is a flow chart of a method for forming first target data sub-objects consistent with embodiments of the present disclosure.

FIG. 4 is a schematic diagram showing compressing a first data object from a column direction consistent with embodiments of the present disclosure.

FIG. 5 is a flow chart of another data processing method consistent with embodiments of the present disclosure.

FIG. 6 is a schematic diagram showing compressing a second data object consistent with embodiments of the present disclosure.

FIG. 7 is a flow chart of another data processing method consistent with embodiments of the present disclosure.

FIG. 8 is a schematic diagram showing an internal structure of PE consistent with embodiments of the present disclosure.

FIG. 9 is a flow chart of performing data processing on each first data object and each second data object consistent with embodiments of the present disclosure.

FIG. 10 is a schematic diagram showing hardware of a PE array consistent with embodiments of the present disclosure.

FIG. 11 is a schematic diagram showing inputting only one data to a PE array of a matrix A and a matrix B, consistent with embodiments of the present disclosure.

FIG. 12 is a schematic diagram of a data processing device consistent with embodiments of the present disclosure.

FIG. 13 is a schematic diagram of a data processing chip consistent with embodiments of the present disclosure.

FIG. 14 is a schematic diagram of an electronic apparatus consistent with embodiments of the present disclosure.

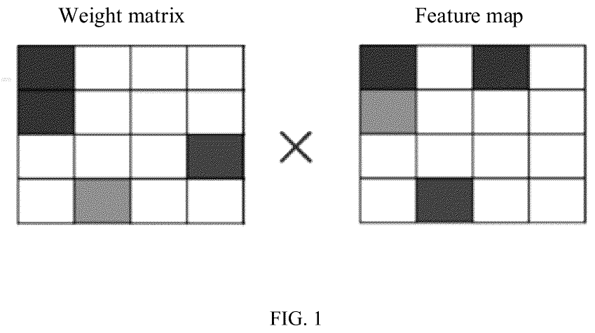

### DETAILED DESCRIPTION OF THE EMBODIMENTS

Embodiments of the present disclosure are described hereinafter with reference to the accompanying drawings. The described embodiments are only some of the embodiments of the present disclosure, and not all of the embodiments. Based on the embodiments in the present disclosure, all other embodiments obtained by those skilled in the art without creative work are within the scope of the present disclosure. For the sake of clarity and conciseness, the description of well-known functions and structures is omitted in the following description.

Operations in a neural network mainly include multiplication and addition (for example, multiplication and addition operations involved in matrix multiplication of weight matrices in a Transformer network). Zero values do not contribute to the final calculation result. If only valid values (non-zero values) are transmitted and stored during data transmission and storage, the bandwidth needed for transmission and storage can be greatly reduced. If the zero values are skipped during data calculation, the computing performance of the system can be greatly improved, and the resource utilization of the system can be improved.

However, relevant hardware currently responsible for data processing of neural network models, such as related commercial chips, does not support unstructured weight sparse processing. The zero-value weights still participate in the processing and occupy the computing time. Therefore, in the data processing based on the neural network model, there are a series of problems such as low computing performance, high demand for resources such as storage and transmission, and low resource utilization.

There are two main types of data processing of weight matrices and feature maps in neural networks: convolution operations and matrix multiplication operations. Currently, large language models (LLMs) such as ChatGPT are very popular and have become the most important applications in the field of artificial intelligence. The large language models such as ChatGPT are generative language models based on Transformer networks. The core of Transformer is the attention mechanism, and more than 90% of the calculations in attention involve matrix multiplication operations. In practical applications, convolution operations can also be converted into matrix multiplication operations through corresponding conversion rules. The neural network model can perform one-dimensional convolution, two-dimensional convolution, or three-dimensional convolution on the feature map without restriction, depending on actual needs. For example, for a one-dimensional convolution kernel of size 1×3, a one-dimensional convolution can be performed on a 1×3 feature map based on a 1×3 weight matrix. For a two-dimensional convolution kernel of size 3×3, a two-dimensional convolution can be performed on a 3×3 feature map based on a 3×3 weight matrix.

In neural network models such as large language models, the number of parameters reaches hundreds of billions, and memory bandwidth is the main bottleneck of the system. Matrix multiplication can be divided into two implementation methods: inner product and outer product. The outer product can fully use data, improve the calculation/load ratio, and reduce bandwidth requirements.

At present, mainstream commercial chips basically use the inner product method to implement matrix multiplication operations of neural network models such as large language models, and the sparsity of data such as weight matrices is not specially optimized. Correspondingly, in data processing based on neural network models such as the large language models, there are a series of problems such as low computing performance, high demand for resources such as storage and transmission, and low resource utilization as mentioned above.

Based on this, the present disclosure provides a data processing chip, a data processing method, and a data processing device, which mainly uses the outer product method to implement matrix multiplication operations in neural networks such as Transformers to reduce bandwidth requirements. Also, the sparse characteristics of data such as weight matrices in the neural networks may be used to efficiently compress data in the neural networks to make full use of system resources, further reducing bandwidth requirements, and improving system resource utilization and computing efficiency.

The data processing chip, the data processing method, and the data processing device provided in the present disclosure may be applied to but are not limited to electronic apparatuses such as personal computers or servers, and may be applied to but are not limited to natural language processing, image processing, video processing, speech recognition, industrial detection (such as equipment defect detection) or other fields.

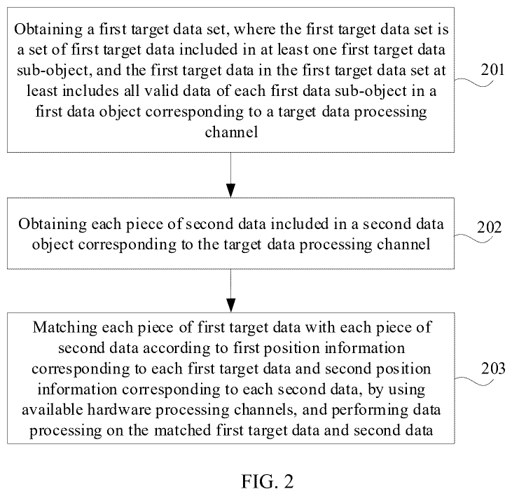

The present disclosure provides a data processing method. As shown in FIG. 2, which is a flow chart of a data processing method consistent with the present disclosure, in one embodiment, the data processing method includes 201 to 203.

201, a first target data set is obtained, where the first target data set is a set formed by first target data included in at least one first target data sub-object and the first target data in the first target data set at least includes all valid data of each first data sub-object in a first data object corresponding to a target data processing channel.

The data processing of a neural network model (such as a Transformer-based neural network model) based on the outer product method is used as an example to illustrate the present disclosure.

The target data processing channel may be, but is not limited to, an input channel of a network layer of the neural network model. For example, for image processing based on the neural network model, the target data processing channel may include any one or more input channels of the R, G, and B primary color input channels of the model network layer and the texture input channel, or the semantic input channel.

The valid data in the first data object may be data included in the first data object that has contribution value to the data processing of the first data object, while data included in the first data object that does not have contribution value to its data processing may be regarded as non-valid data or invalid data of the first data object.

Optionally, the first data object may be a data matrix including multiple pieces of data to be processed, and each first data sub-object in the first data object may be a column in the data matrix. For the data processing scenario of the neural network model, the first data object may be a weight matrix or a feature map. The weight matrix corresponding to the corresponding input channel of the network layer of the neural network model is used as an example to illustrate the present disclosure. For the case where the first data object is a weight matrix, each first data sub-object in the first data object may be a column in the weight matrix, and the valid data in the first data sub-object included in the first data object may be the non-zero values in the columns of the weight matrix. Since the non-zero values have contribution values to the operation of the model network, the non-zero weights may be regarded as the valid data in the first data sub-objects in the first data object. Correspondingly, since the zero values have no contribution value to the operation of the model network, the zero-value weights in the weight matrix may be regarded as invalid data.

In the embodiment of the present disclosure, for the sparse characteristics of the first data object (such as the weight matrix of the network layer of the neural network model), the data in the first data object may be compressed to reduce the number of the first data sub-objects included in the first data object, thereby optimizing the data processing of the first data object (such as optimizing the matrix multiplication operations based on the outer product of the sparse matrix), and solving various problems in the existing technology.

In one embodiment, data compression processing of the first data object may be implemented by aggregating all valid data of each first data sub-object in the first data object into a certain number of first data sub-objects, and based on this processing, the number of first data sub-objects included in the first data object may be reduced.

When the first data object is a data matrix including multiple pieces of data to be processed, and each first data sub-object included in the first data object is a column in the data matrix, compressing the data in the first data object, may at least include compressing the data matrix of the first data object from the row direction. By compressing the data matrix of the first data object from the row direction, all valid data in each original column of the data matrix of the first data object may be gathered into a portion of columns in the original columns. For example, by making the valid data in the corresponding original columns of the data matrix of the first data object occupy the positions of invalid data such as zero-value weight in other original columns (columns other than the corresponding original columns), all valid data may be gathered into a portion of the columns of the first data object, such that the corresponding portion of the columns of the first data object at least include the valid data while the other portion of the columns does not include any valid data. Therefore, the columns that do not include any valid data may be directly eliminated, to realize the compression of the first data object and reduce the number of the first data sub-objects included therein.

After performing the above compression processing on the first data object, at least one first target data sub-object may be obtained, and the at least one first target data sub-object may be first data sub-objects that at least include the valid data after the compression is completed. The first target data included in the at least one first target data sub-object may form a first target data set. The first target data in the first target data set may at least include all valid data of the first data sub-objects in the first data object corresponding to the target data processing channel, such as at least all valid data of each column in the weight matrix corresponding to the neural network input channel. In addition to all valid data, the first target data may also include a certain amount of invalid data, and of course, it may not include any invalid data, depending on the actual situation.

That is, based on the above compression processing, at least a portion of the invalid data in the first data object may be eliminated, and all valid data may be retained, to reduce the data processing amount of the first data object while avoiding affecting the data processing result of the first data object, thereby ensuring the accuracy of the data processing result.

After compression is completed, each valid data included in each first data sub-object may be in one same first target data sub-object, and the number of the first target data sub-objects obtained after compression may be less than the number of the first data sub-objects included in the first data object. For example, when the first data object is a data matrix, assuming that a column including at least the valid data after compression is called a first target column, after compression is completed, each valid data included in each original column of the data matrix is in one same first target column, and the number of the obtained first target columns may be less than the number of the original columns in the data matrix.

When the first data object is the weight matrix of the network layer of the neural network model, in actual applications, when the model training is completed, the weight matrix of the model network layer may be compressed based on the above embodiments, and the first target data set obtained based on the compression processing (such as the data in each first target column obtained after compression including at least the valid data) may be stored. When the model is needed to be used for data processing later, the stored first target data set may be directly read through 201 to perform the needed processing on it, but it is not limited to this. In some other embodiments, when the model is needed to be used for data processing, the weight matrix of each network layer of the model may be compressed in real time, and the first target data set obtained by real-time compression may be read through 201 to perform the needed processing on it, which may be determined according to the actual application requirements.

After the compression is completed, the corresponding position information may be also constructed for each piece of first target data in the first target data set. In one embodiment of the present disclosure, the position information corresponding to the first target data may be called the first position information, which is used as the index of the first target data to indicate the corresponding position (original position) of the first target data in the first data object.

When the first data object is a data matrix such as a weight matrix, optionally, the first position information corresponding to the first target data may include a row index and a column index of the first target data, which are respectively used to indicate the original row and original column of the first target data in the data matrix of the first data object.

After reading the first target data set in 201, the first position information corresponding to each piece of first target data in the first target data set may be combined to perform the needed processing on the first target data.

At 202, each piece of second data included in a second data object corresponding to the target data processing channel is obtained.

Optionally, the second data object may also be a data matrix including multiple pieces of data to be processed. For the data processing scenario of the neural network model, the second data object may be a feature map corresponding to a corresponding input channel of the network layer of the neural network model, and the second data included in the second data object may be feature values in the feature map.

The second data object may also include valid data and invalid data. The valid data of the second data object may be data included in the second data object that has contribution values to the data processing of the second data object, while the data included in the second data object that does not have contribution value to its data processing may be regarded as non-valid data or invalid data of the second data object. Taking the second data object as the feature map as an example, based on whether the feature values with different values contribute to the data operation of the feature map, the non-zero feature values in the feature map may be determined as valid data of the feature map, and the zero feature values may be regarded as non-valid data or invalid data.

The feature graph may be, but is not limited to, various types of data to be processed, such as images or voices, depending on the specific application scenario.

When data processing is needed for the first data object and the second data object, in addition to reading the first target data set corresponding to the first data object (the first target data set obtained after the above compression processing is performed on the first data object), it may be also necessary to read the second data included in the second data object, to participate in data processing together with the data in the first target data set. For example, for application scenarios in corresponding fields such as natural language processing, image processing, video processing, speech recognition, or industrial detection (such as equipment defect detection), when it is necessary to use artificial intelligence models such as large language models to perform corresponding data processing, in addition to reading the first target data set corresponding to the weight matrix of the input channel of the model network layer, it may be also necessary to read the various eigenvalues included in the feature graph corresponding to the input channel, to participate in model processing together with the read eigenvalues and the data in the first target data set corresponding to the weight matrix.

The order of 202 and 201 may not be limited. Either of 202 and 201 may be executed first in a serial manner and the other may be executed later. 202 and 201 may also be executed simultaneously in a parallel manner, depending on the actual application situation.

Each piece of second data in the second data object may correspond to one position information. For ease of description, the position information corresponding to the second data is called second position information, which may be used as the index of the second data to indicate the position (original position) corresponding to the second data in the second data object.

When the second data object is a data matrix such as a feature map, optionally, the second position information corresponding to the second data may include a row index and a column index of the second data, which may be respectively used to indicate the original row and original column of the second data in the data matrix of the second data object.

At 203, according to the first position information corresponding to each piece of first target data and the second position information corresponding to each piece of second data, the first target data and the second data may be matched by using the available hardware processing channels, and the matched first target data and the second data may be processed.

After obtaining the first target data set and each piece of second data included in the second data object, the available hardware processing channels may be further used to process the first target data and the second data according to the first position information corresponding to each piece of first target data and the second position information corresponding to each piece of second data.

One available hardware processing channel may be a hardware computing channel that may be currently unoccupied and may be scheduled to perform the needed operation on the data in the system of an electronic apparatus such as a personal computer or a server. The available hardware processing channel may be, but is not limited to, a computing channel based on hardware such as an operator and a register. Each channel may include a needed number of operators and/or registers, and may also include other needed hardware.

Optionally, the data processing performed on each piece of first target data and each piece of second data may include, but is not limited to, multiplication and accumulation processing. That is, firstly, the current first target data to be processed and its corresponding/matched second data may be multiplied, and then the corresponding multiplication results may be accumulated. The present disclosure is not limited to this. When applying the present disclosure, the data processing performed may be determined according to the actual application requirements.

Each piece of data to be processed in the first data object may correspond to/match one corresponding data to be processed in the second data object, to form a data pair to be processed by matching between the first data object and the second data object and performing the needed data processing on the data pair to be processed. For example, two data to be processed included in the data pair to be processed may be multiplied, and multiplication results of the corresponding different data pairs to be processed may be accumulated, etc.

Whether a certain data to be processed in the first data object matches a certain data to be processed in the second data object (i.e., whether they should be matched into a corresponding data pair to be processed) may depend on the positions of the two data to be processed in the data objects to which they belong respectively. The data at the matching positions between the first data object and the second data object may be correspondingly matched data to be processed. The matching positions between the first data object and the second data object may be determined by the data processing rules for the first data object and the second data object.

Therefore, for each piece of first target data in the first target data set (essentially a corresponding data to be processed in the first data object), the second position information matched in the second data object by the first position information corresponding to the first target data may be determined according to the data processing rules for the first data object and the second data object, and the data to be processed at the position indicated by the matched second position information in the second data object may be used as the second data corresponding to/matching the first target data, thereby forming one data pair to be processed with the first target data to participate in the needed data processing. For example, when the first data object and the second data object are respectively data matrices (for example, a weight matrix and a feature map, respectively), the row index and column index corresponding to the first target data that match the row index and column index in the second data object may be determined according to the data processing rules for the first data object and the second data object, and the data to be processed at the row and column positions indicated by the matched row index and column index in the second data object may be used as the second data corresponding to the first target data, to be matched with the first target data to form one data pair to be processed.

The data processing of the first data object and the second data object in the embodiments of the present disclosure may mainly include matrix multiplication based on the outer product. For example, matrix multiplication based on the outer product may be performed on the weight matrix and the feature map.

The matrix multiplication based on the outer product on the first data object and the second data object may include multiplying the columns of the data matrix of the first data object with the rows in the data matrix of the second data object. For example, each piece of data in each column of the data matrix of the first data object may correspond to each piece of data in the corresponding row of the data matrix of the second data object one-to-one to form one data pair to be processed, and the multiplication operation may be performed on the two data included in the data pair to be processed. The multiplication results corresponding to the data pairs to be processed with the same row index of the first multiplier and the same column index of the second multiplier in different data pairs to be processed may be accumulated.

Therefore, for the matrix multiplication operation based on the outer product, in 203, for each piece of first target data in the first target data set, according to the column index corresponding to the first target data in the first data object and the row index corresponding to the second data in the second data object, each piece of second data on the row corresponding to the column index in the second data object may be used as the second data corresponding to the first target data, to form one data pair to be processed that matches the first target data and participate in the needed operation (such as multiplication operation and accumulation operation based on this).

In the data processing method provided in the embodiments of the present disclosure, the data included in the first data object may be compressed based on the sparse characteristics of the data in the first data object. By compressing each first data sub-object in the first data object into at least one first target data sub-object to form the first target data set and making the number of the first target data sub-objects less than the number of the first data sub-objects, the data processing amount of the first data object may be significantly reduced, thereby improving the computing performance of the system, reducing the resource requirements such as storage, transmission and operation, and improving the system resource utilization and computing efficiency. For application scenarios such as natural language processing, image processing, video processing, speech recognition, or industrial detection, the processing efficiency of various applications such as natural language processing, image processing, and speech recognition may be improved accordingly, and the utilization rate of system resources may be improved.

Further, since the first target data in the first target data set obtained after compression includes all valid data of each first data sub-object in the first data object, the compression processing performed may only remove at least a portion of the invalid data in the first data object and retain all valid data, the data processing result of the first data object may not be affected, thereby ensuring the accuracy of the data processing result. Compared with the matrix multiplication operation based on the inner product, the embodiments of the present disclosure may adopt the outer product method to implement the matrix multiplication operation, which may make full use of the data and improve the calculation/load ratio, thereby further reducing the bandwidth requirement.

Even further, for the case where the first data object is data such as a weight matrix that may be obtained in advance but does not have to be obtained in real time, at least part of the invalid data in the first data object may be eliminated based on soft processing. That is, before the first data object is sent to the hardware for processing, at least part of the invalid data may be removed. Therefore, for this situation, the data processing method provided by the present disclosure may be still applicable to related hardware that currently does not support weight sparsification processing (zero-value weights are still involved in processing and take up computing time), such as related commercial chips. For the case where the first data object is data that needs to be obtained in real time, such as a feature map, the hardware may perform real-time data compression processing on it.

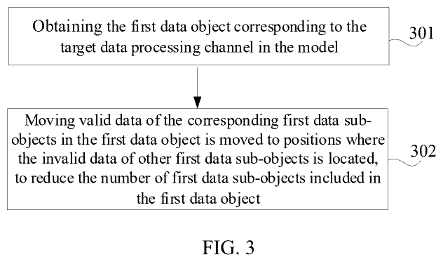

In an optional embodiment, as shown in FIG. 3, which is a flow chart for forming the first target data sub-objects, based on the compression idea described above, compressing the data in the first data object to form the first target data sub-objects, includes 301 to 302.

At 301, the first data object corresponding to the target data processing channel in the model is obtained.

The model here may be a neural network model, which may be, but is not limited to, a large language model based on a Transformer network. The target data processing channel may be, but is not limited to, an input channel of a network layer of a neural network model.

In this embodiment, the first data object may be a first data matrix including multiple pieces of data to be processed, and one first data sub-object in the first data object may be a column in the first data matrix. For the data processing scenario of the neural network model, the first data object may be a weight matrix corresponding to the input channel of the model network layer.

At 301, when the training of the neural network model is completed, the weight matrix corresponding to the input channel of the network layer of the neural network model may be obtained as the first data object, to realize the compression processing of the data in the first data object in combination with the subsequent steps. The present disclosure is not limited to this. In another embodiment, after the training of the neural network model is completed, when the model needs to be used to perform data processing, the weight matrix corresponding to the input channel of the network layer of the neural network model may be obtained in real time as the first data object, to perform the needed data compression processing on it.

At 302, the valid data of the corresponding first data sub-objects in the first data object is moved to positions where the invalid data of other first data sub-objects is located, to reduce the number of first data sub-objects included in the first data object.

The other first data sub-objects may include first data sub-objects other than the corresponding first data sub-objects in the first data object.

In this embodiment, by moving the valid data of the corresponding first data sub-objects in the first data object to the positions where the invalid data of the other first data sub-objects is located, the valid data in the first data object may be aggregated, and the valid data may be aggregated from the original first data sub-objects to a part of the number of first data sub-objects, to reduce the number of first data sub-objects included in the first data object and realize the compression of the first data object.

The at least one first target data sub-object may include the first data sub-objects obtained after the move is completed and at least including valid data.

In the case where the first data object is a first data matrix such as a weight matrix, at least the data in the first data matrix may be compressed from the row direction. That is, the valid data of the corresponding columns in the first data matrix may be moved to the position where the invalid data of other columns other than the corresponding columns in the first data matrix is located, to reduce the number of columns included in the first data matrix. Therefore, the at least one first target data sub-object may correspondingly include: the first target columns obtained after the move is completed and at least including the valid data.

When the valid data of the corresponding columns in the first data matrix is moved to the positions of the invalid data of the other columns other than the corresponding columns in the first data matrix, optionally, the valid data of the corresponding columns in the first data matrix may be moved to the positions of the invalid data of the other columns on the left side of the corresponding columns in the first data matrix based on the left compression method, such that the valid data of the corresponding columns occupies the positions of the invalid data such as the zero-value weight of the other columns on the left side of the corresponding columns. The present disclosure is not limited to this. In another embodiment, the valid data of the corresponding columns in the first data matrix may also be moved to the positions of the invalid data of the other columns on the right side of the corresponding column in the first data matrix based on the right compression method, such that the valid data of the corresponding columns occupies the positions of the invalid data such as the zero-value weight of the other columns on the right side of the corresponding column. Through the above-mentioned left compression method or right compression method, the valid data may be aggregated into some columns of the first data matrix, such that the some columns at least include valid data, and the other columns other than the some columns do not include valid data.

In the embodiments of the present disclosure, the data in one same column of the first data matrix may be located in the same first target column after the movement is completed.

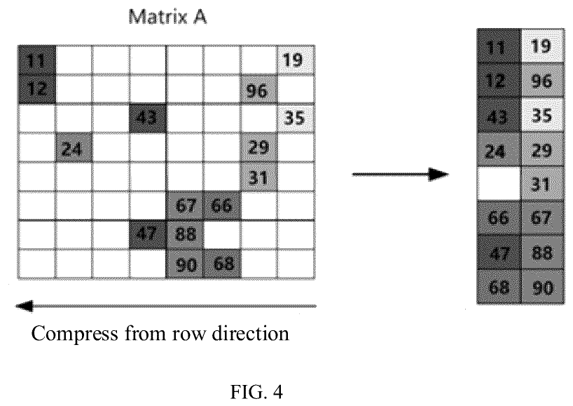

As shown in FIG. 4, assuming that the first data object is the sparse matrix A (Matrix A), the first data sub-objects in the first data object is a column in the matrix A, and the matrix A includes 8 columns of data in total where the column indexes are 1, 2, 3 . . . 8 from left to right, the blank squares represent the zero-valued data in the matrix A, i.e., invalid data, and the non-blank squares, i.e., the gray boxes, represent the non-zero-valued data in the matrix A, i.e., valid data. When compressing the matrix A, exemplarily, based on the compression method from the left in the row direction, the valid data in the 2nd, 4th, and 6th columns of the matrix A are moved to the positions where the invalid data is located in the 1st column, and the valid data in the 7th and 8th columns of the matrix A are moved to the positions where the invalid data is located in the 5th column. The first data sub-objects may at least include valid data obtained after the movement is completed as shown in FIG. 4. The first data sub-objects may be obtained after adding the valid data of other corresponding columns to the original 1st column and the original 5th column. In the embodiments of the present disclosure, the first data sub-objects at least including the valid data obtained after the movement is completed may be referred to as the first target data sub-objects, and the number of the first target data sub-objects may be less than the number of original first data sub-objects included in the first data object. For example, in this example, its number is 2, which is less than the number of the original columns included in the matrix A, i.e., 8. Of course, it is also possible to compress the data of matrix A from the row direction by compressing to the right, and there is no restriction on this. Although different compression methods to the left and right may result in different compression results for matrix A, since the data of matrix A is subsequently processed according to the first position information corresponding to each piece of first target data after compression (used to indicate the original positions of the first target data in matrix A), the first position information corresponding to each piece of first target data may be fixed, which may not affect the data processing results of matrix A. Both methods may be able to ensure the accuracy of the data processing results of matrix A.

The first target data sub-objects in this example may also be the first target columns mentioned above. After the move is completed, the data in the same column originally in matrix A may be in the same first target column. For example, the two valid data in the original 4th column may both be in the 1st column after the move is completed, and the three valid data in the original 7th column may all be in the 5th column after the move is completed.

When compressing the first data object such as the first data matrix from the row direction, the valid data may be in the same row after the move as before the move (that is, the data move may not change the row where the valid data is located), or it may be in different rows (that is, the data move may change the row where the valid data may be located). The embodiments of the present disclosure have no requirements for the row where the valid data may be located after the move. In implementation, preferably, when the valid data is moved, the row of the data may be changed as little as possible to simplify the movement logic of the valid data. For example, as shown in FIG. 4, the two valid data in the original 4th column may be in the 3rd row and the 7th row respectively. After the move is completed based on the left compression method, the two data may be in the 1st column, or may be in the 3rd row and the 7th row of the 1st column respectively. The row where the data is located may not change before and after the move. It may be directly translated in the row direction without changing its row index, which simplifies the movement logic when the data is moved.

After compressing the first data matrix from the row direction, optionally, the compression result obtained by compressing the first data matrix from the row direction, that is, each of the first target columns, may be further compressed from the column direction. Further compressing each of the first target columns from the column direction may include removing invalid data (if any) in each of the first target columns to obtain each of the first target columns that do not include any invalid data, thereby further reducing the amount of data processing for the first data matrix, i.e., the first data object.

In this embodiment, by compressing the data in the first data object, the data in the first data object may be aggregated from the original first data sub-objects to a certain number of first data sub-objects, reducing the number of the first data sub-objects included in the first data object, and correspondingly reducing the amount of data processing for the first data object, thereby improving the computing performance of the system, reducing the demand for resources such as storage, transmission and calculation, and improving the utilization of system resources.

Further, for the case where the first data object is the first data matrix, in this embodiment, the data originally in one same column in the first data matrix may be controlled to be located in one same first target column after the move is completed, and may not be compressed into different first target columns. This may facilitate the subsequent use of hardware to perform outer product-based data processing on the compressed data (each piece of first target data in the first target data set corresponding to the first data object), simplifying the data reading logic. Therefore, each row of data in the second data object may only need to be read once, and multiple readings may not occur, thereby further reducing the bandwidth requirements and correspondingly further improving the system's computing efficiency.

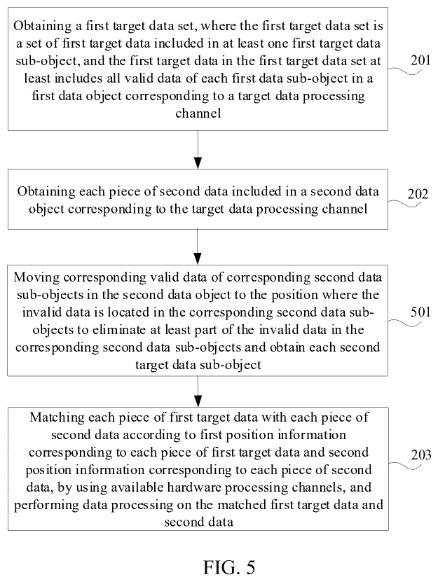

In an optional embodiment, as shown in FIG. 5, which is a flow chart of a data processing method provided by the present disclosure, after 202, the data processing method may further include:

501, moving the corresponding valid data of the corresponding second data sub-objects in the second data object to the positions where the invalid data is located in the corresponding second data sub-objects, to remove at least part of the invalid data in the corresponding second data sub-objects and obtain each second target data sub-object, such that data processing may be performed on each piece of first target data and second target data in each second target data sub-objects.

Each second target data sub-object may be a corresponding second data sub-object including at least valid data obtained by moving to remove the corresponding invalid data.

For the data processing of the first data object and the second data object, in this embodiment, a technical solution of compressing the data of the second data object based on the sparse characteristics of the data in the second data object may be further included. For example, the data in the feature map may be compressed based on the data sparse characteristics of the feature map.

For each second data sub-object in the second data object, when there is invalid data in the second data sub-object, by moving the corresponding valid data of the second data sub-object to the position of the invalid data in the second data sub-object, the valid data included in the second data sub-object may be aggregated inside the second data sub-object, and after completing the effective data aggregation based on the move, the invalid data in the second data sub-object may be eliminated to obtain the second target data sub-object corresponding to the second data sub-object. In the implementation, the compression of the second data object may be achieved by moving the corresponding valid data of the second data sub-object to the position of the invalid data on the left side of the corresponding valid data in the second data sub-object, but it is not limited to this. The compression of the second data object may also be achieved by moving the corresponding valid data of the second data sub-object to the positions of the invalid data on the right side of the corresponding valid data in the second data sub-object.

Optionally, corresponding to the first data object being a first data matrix with multiple pieces of data to be processed, the second data object may be a second data matrix with multiple pieces of data to be processed, such as a feature map. One second data sub-object may be a row in the second data matrix. In this case, one second target data sub-object may correspondingly include: a row obtained by moving the valid data in the row in the second data matrix (based on the left or right compression method) to the positions of the invalid data in the row to which it belongs to remove at least part of the invalid data.

The following example is used for illustration.

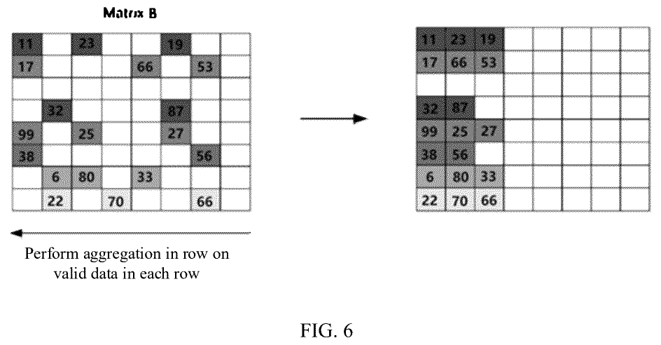

Assuming that the second data object/second data matrix is a sparse matrix B (Matrix B), as shown in FIG. 6, the blank squares represent the 0-valued data in the matrix B, that is, the invalid data. The non-blank squares, that is, the gray boxes, represent the non-0-valued data in the matrix B, that is, the valid data. When compressing the matrix B, the valid data in each row of the matrix B may be moved to the positions of the corresponding invalid data on the left side of the valid data in the row to which it belongs, to achieve the aggregation of the valid data of each row within the row. Therefore, the invalid data in each row may be removed, to achieve the compression of the matrix B based on the left compression method, and obtain each second target data sub-object of the matrix B.

With respect to the data processing of the first data object and the second data object, these embodiments may further reduce the amount of data processing when processing the first data object and the second data object by compressing the data of the second data object based on the sparse characteristics of the data in the second data object, and accordingly may further improve the computing performance of the system, reduce the demand for resources such as storage, transmission and computing, and improve system resource utilization and computing efficiency.

Further, because of the compression of the second data object, only at least part of the invalid data in the second data object may be eliminated, and all valid data may be retained, such that there is no impact on the data processing of the first data object and the second data object (such as the multiplication operation of the weight matrix and the feature map), and the accuracy of the data processing results may be guaranteed.

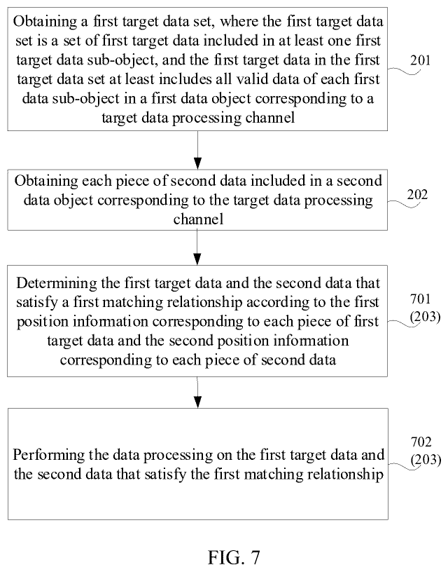

In an optional embodiment, as shown in FIG. 7, which is a flow chart of a data processing method provided by the present disclosure, matching the first target data and the second data according to the first position information corresponding to each piece of first target data and the second position information corresponding to each piece of second data by using the available hardware processing channel, and performing data processing on the matched first target data and the second data, may include 701 and 702.

At 701, the first target data and the second data that satisfy the first matching relationship are determined according to the first position information corresponding to each piece of first target data and the second position information corresponding to each piece of second data by using the available hardware processing channel.

In this embodiment, the first position information corresponding to the first target data may at least include the column index of the column to which the first target data belongs in the first data object. Illustratively, for example, the first position information may include the column index of the column to which the first target data belongs in the first data object and the row index of the row to which it belongs, to indicate the column and row to which the first target data belongs in the first data object respectively.

The second position information corresponding to the second data may at least include the row index of the row to which the second data belongs in the second data object. For example, the second position information may include the row index of the row to which the second data belongs in the second data object and the column index of the column to which the second data belongs, to indicate the row and column to which the second data belongs in the second data object, respectively.

In the embodiment of the present disclosure, the first data object may be a first data matrix, the second data object may be a second data matrix, and the data processing of the first data object and the second data object may be a matrix multiplication operation based on the outer product. As described above, the columns in the first data matrix may need to be multiplied by the rows in the second data matrix. For example, each piece of data in each column of the first data matrix may need to correspond one-to-one with each piece of data in the corresponding row of the second data matrix to form one data pair to be processed, and the two data included in the data pair to be processed may be multiplied. Therefore, for the matrix multiplication operation based on the outer product, the available hardware processing channel may be used to determine the first target data and the second data whose corresponding column index in each piece of first target data is the same as the corresponding row index in each piece of second data as the first target data and the second data that satisfy the first matching relationship. The first target data and the second data that satisfy the first matching relationship may correspondingly form one data pair to be processed in the matrix multiplication operation based on the outer product to participate in subsequent data calculation and processing.

At 702, data processing is performed on the first target data and the second data that satisfy the first matching relationship.

After determining the first target data and the second data that satisfy the first matching relationship, the needed data processing may be further performed on the first target data and the second data that satisfy the first matching relationship based on the data processing rules for the first data object and the second data object. The data processing may include, but is not limited to, multiplication and accumulation processing.

For the matrix multiplication operation based on the outer product, after determining the first target data and the second data that satisfy the first matching relationship, the first target data and the second data that satisfy the first matching relationship may be multiplied to obtain the corresponding multiplication operation results, and the multiplication operation results that satisfy the second matching relationship among the different multiplication operation results may be accumulated to obtain the corresponding accumulation operation result.

For example, for the matrix multiplication operation based on the outer product in the present disclosure, after determining the first target data and the second data whose corresponding column index in each of the first target data is the same as the corresponding row index in each of the second data, the determined first target data and the second data may be used as the first target data and the second data satisfying the first matching relationship to form one data pair to be processed, and the multiplication operation may be performed on the first target data and the second data included in each piece of data pair to be processed. On this basis, the multiplication operation results corresponding to the data pairs to be processed whose row index of the first multiplier is the same and the column index of the second multiplier is the same in different data pairs to be processed may be accumulated as the multiplication operation results satisfying the second matching relationship, thereby obtaining the corresponding accumulated operation result, which may be used as a value in the matrix multiplication operation results (also a matrix) based on the outer product of the first data object and the second data object.

In this embodiment, each piece of first target data participating in the data processing of the first data object may be the data in each first target data sub-object obtained after compressing the first data object from the row direction, or may be the data in each first target data sub-object obtained after compressing the first data object from the row direction and the column direction; and, each piece of second data participating in the data processing of the second data object may be all the original data included in the second data object, or may be the data in the second data sub-object after eliminating the corresponding invalid data after performing movement-based effective data aggregation on the data in the second data object within the second data sub-object (such as the row to which it belongs). There may be no limitation to this and it may be determined according to the actual application situation.

In this embodiment, when processing each piece of first target data in the first data object and each piece of second data in the second data object, since at least part of the data involved in the processing (such as the first target data, or the first target data and the second data) is the data obtained after data compression is performed on the data object, at least part of the invalid data in the data object may be eliminated based on the data compression, thereby reducing the data processing amount of the first data object and the second data object, which may correspondingly improve the computing performance of the system, reduce the demand for resources such as storage, transmission and operation, and improve the system resource utilization and operation efficiency. Compared with the matrix multiplication operation based on the inner product, this embodiment may fully utilize the data and improve the calculation/load ratio by using the outer product method to implement the matrix multiplication operation, thereby further reducing the bandwidth demand.

In another optional embodiment, there may be a plurality of available hardware processing channels.

In this embodiment, each available hardware processing channel may include a first computing component and a second computing component connected to each other, and first computing components respectively included in the plurality available hardware processing channels may be connected in series in sequence.

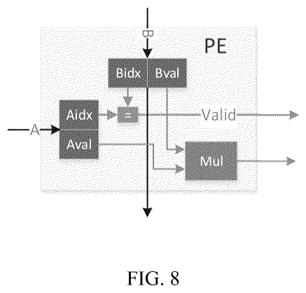

Optionally, each first computing component may be a PE (Process Element). As shown in FIG. 8, which is a schematic diagram showing the internal structure of PE, each PE includes a multiplier (Mul) for performing multiplication operations on data. Each second computing component may be an accumulator connected to one corresponding PE, which is used to perform accumulation operations on data.

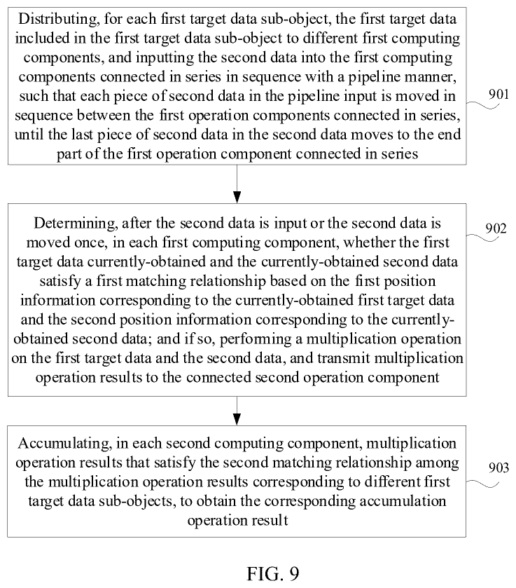

In this embodiment, as shown in the flow chart in FIG. 9, in 203, matching the first target data and the second data according to the first position information corresponding to each piece of first target data and the second position information corresponding to each piece of second data by using the available hardware processing channel, and performing data processing on the matched first target data and second data, may include 901 to 903.

At 901, for each first target data sub-object, different first target data included in the first target data sub-object is distributed to different first computing components, and the second data is sequentially input into the first computing components in series in a pipeline manner, such that each piece of second data is sequentially moved between the first computing components in series until the last piece of second data in the second data is moved to the end part of the first computing components connected in series.

In 901, the first target data of the corresponding number in each first target data sub-object may be distributed one-to-one to the first computing components of different available hardware processing channels according to the number of available hardware processing channels. Optionally, the number of available hardware processing channels may be equal to the number of rows of the first data object, such as the first data matrix. In this case, all the first target data in one first target data sub-object may be distributed one-to-one to different first computing components each time. For example, all the first target data in one first target column may be distributed one-to-one to different PEs in the series of PEs each time. The series of PEs may be used for parallel processing of data operations of each piece of data included in each first target column obtained after compression of the first data matrix.

For each piece of second data in the second data object, the second data may be sequentially input into each first computing component in series in a pipeline manner, and each piece of second data may be sequentially moved between each first computing component in series based on the pipeline manner. When moving to each first computing component such as PE, the first computing component such as PE may determine whether it needs to perform a multiplication operation on the first target data and the second data it obtains, and perform the corresponding multiplication operation when the determination result is yes, until the last piece of second data in the second data is moved to the end part of the first computing components connected in series.

At 902, after the second data is input or the second data is moved once, in each first computing component, according to the first position information corresponding to the currently-obtained first target data and the second position information corresponding to the currently-obtained second data, whether the currently-obtained first target data and the currently-obtained second data meet the first matching relationship is determined. When the currently-obtained first target data and the currently-obtained second data meet the first matching relationship, the multiplication operation is performed on the first target data and the second data, and the multiplication result is transmitted to the connected second computing component.

After distributing the first target data to each first computing component and inputting the second data into each first computing component in series in a pipeline manner, or after each movement of the second data, in each first computing component, according to the first position information corresponding to the currently-obtained first target data and the second position information corresponding to the second data, whether the currently-obtained first target data and the currently-obtained second data satisfy the first matching relationship may be determined. When the currently-obtained first target data and the currently-obtained second data meet the first matching relationship, the multiplication operation is performed on the first target data and the second data. Otherwise, when the currently-obtained first target data and the currently-obtained second data do not meet the first matching relationship, there may be no need to perform the multiplication operation on the currently-obtained first target data and the currently-obtained second data.

Taking the first computing components as PEs as an example, each PE connected in series may specifically determine whether the column index of the currently-obtained first target data is the same as the row index of the currently-obtained second data. When the column index of the currently-obtained first target data is the same as the row index of the currently-obtained second data, it may be determined that the two satisfy the first matching relationship, and the multiplication operation may be performed on the two accordingly. Otherwise, it may be determined that the two do not satisfy the first matching relationship, and the multiplication operation may not need to be performed on the two accordingly.

When the first computing component such as PE performs the multiplication operation on the first target data and the currently-obtained second data, the obtained multiplication operation result may be transmitted to the connected second computing component, such as that PE transmits its current multiplication operation result to the accumulator connected to the PE.

Conversely, when the first computing component such as PE does not perform a multiplication operation on the first target data and the currently-obtained second data, no data may be output to the connected second computing component such as the accumulator (which can be understood as the output result is empty), or 0 may be output.

At 903, in each second computing component, the multiplication operation results that satisfy the second matching relationship between the obtained multiplication operation results are accumulated to obtain the corresponding accumulation operation result.

With the distribution of the first target data included in each first target data sub-object among each first computing component, the input and movement of each piece of second data between each first computing component based on the pipeline method, the determination of whether the obtained first target data and the second data satisfy the first matching relationship by each first computing component, and the execution of multiplication operation and other processing if satisfied, each second computing component may obtain a certain number of multiplication operation results transmitted by the first computing component connected to it.

On this basis, each second computing component may determine the multiplication results that satisfy the second matching relationship between the multiplication results it obtains, and accumulate the multiplication results that satisfy the second matching relationship to obtain the corresponding accumulated operation result.

For example, the accumulator may determine different multiplication results with the same row index of the first multiplier and the same column index of the second multiplier from the multiplication results it obtains, determine the determined different multiplication results as satisfying the second matching relationship, and accumulates the different multiplication results that satisfy the second matching relationship. This may be consistent with the operation rules of the matrix multiplication operation based on the outer product described above, and meet the requirements of the matrix multiplication operation based on the outer product.

It should be noted that, in this embodiment, each piece of first target data participating in the data processing of the first data object may also be the data in each first target data sub-object obtained after compressing the first data object from the row direction, or may also be the data in each first target data sub-object obtained after compressing the first data object from the row direction and the column direction; and, each piece of second data participating in the data processing of the second data object may also be all the original data included in the second data object, or may also be the data in the second data sub-object after eliminating the corresponding invalid data after performing movement-based effective data aggregation on the data in the second data object within the second data sub-object (such as the row to which it belongs). There is no limitation to this and it can be determined according to the actual application situation.

The following is an example of the data processing process provided by this embodiment.

In this example, each piece of first target data involved in the operation may be the data in each first target column obtained by compressing the matrix A described above from the row direction. When compressing the matrix A, the data in an original same column may be kept in the same first target column and may not be compressed into different first target columns, such that each row of data involved in the operation in the matrix B (specifically, the row data obtained after the matrix B is compressed in this example) may only be read once and there may be no multiple readings. That is, each piece of second data involved in the operation may be the data obtained after the matrix B described above is compressed and at least part of the invalid data is eliminated, and the valid data in each row of the data in the matrix B may be closely arranged after the data is compressed, as shown in FIG. 6.

Also, when a column (a first target column) of the matrix A compressed based on the above compression method is multiplied with the matrix B, the partial sum (multiplication and accumulation result) generated by each point may be in a different position (that is, the corresponding accumulator may be different), and there may be no conflict when writing to the memory, such that is may be calculated in parallel at the same time.

In this example, each PE in the PE array may be connected in series to obtain a column of PEs in series. The number of PEs may be equal to the number of rows of matrix A, such that this column of PEs may be able to simultaneously and in parallel process the matrix multiplication operation of one column (first target column) of the compressed matrix A data.

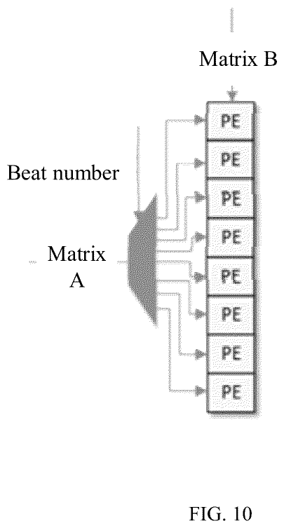

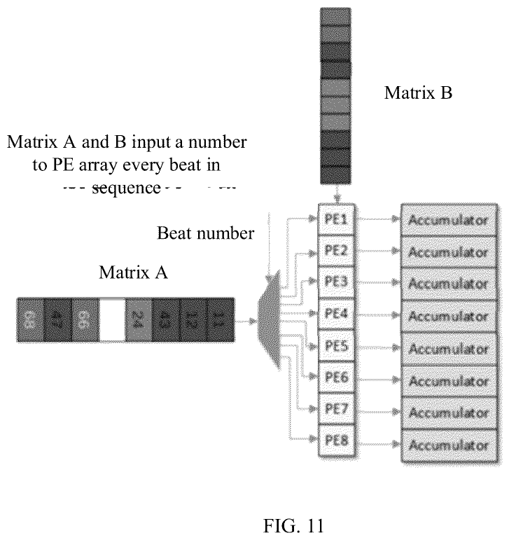

To further reduce the bandwidth requirement, optionally, as shown in FIG. 10 and FIG. 11, where Accumulator in FIG. 11 represents an accumulator, only one data of matrix A and B is sent to the PE array per beat. The data of the first target column of matrix A (Matrix A) is input from the left side of PE, and the row data of matrix B is passed from the top to the PE array in sequence and flows in sequence between the series-connected PEs based on the pipeline method, thereby greatly reducing the bandwidth requirement. When the data of the first target column of matrix A is sent to the PE array in sequence, each first target column is sent to the corresponding PE according to the number of beats, and the data is stored in the PE. The first beat data is sent to PE1, the second beat data is sent to PE2, and the n-th beat data is sent to PEn, until all the data of the first target column is sent to PE. The data of Matrix B flows into the PE array in a pipeline manner, and moves from top to bottom in each beat, flowing in from PE1 and finally flowing out from PE8. Therefore, it is ensured that the data of each column (each first target column) of Matrix A is operated with the data of the corresponding row of Matrix B in PE. The one beat/each beat mentioned here refers to the input, movement or data operation performed on the data to be processed once. Or one beat may also refer to one clock cycle and each operation (such as data input, movement or operation, etc.) corresponds to one or several cycles.

The internal structure of PE is shown in FIG. 8. The first target data in the first target column of matrix A is input from the left side of PE, and the data of matrix B is input from the top of PE. The first target data of matrix A is stored in PE, and the data of matrix B is sequentially transmitted to the next PE based on the pipeline method. In each PE, when the first target data obtained is the same as the index of the second data in matrix B (specifically, the column index of the first target data is the same as the row index of the second data), the two are multiplied, and the multiplication result is sent to the connected accumulator to perform accumulation operation on the corresponding multiplication result in the accumulator as needed. Otherwise, the two data are not multiplied in PE. In the PE of FIG. 8, Aval and Bval respectively represent the first target data and the second data obtained by PE. Aidx and Bidx respectively represent the first position information corresponding to the first target data obtained by PE and the second position information corresponding to the second data, such as the row and column indexes corresponding to the first target data and the second data, etc. Valid represents the valid multiplication result output by PE, which is the result obtained by PE performing multiplication operations on the first target data and the second data when the column index of the first target data obtained is the same as the row index of the second data.

This embodiment proposes an efficient hardware structure suitable for neural networks and proposes a method of using the hardware structure, thereby greatly reducing the bandwidth requirement for data processing of neural network models, overcoming the system bottleneck of neural network models such as large language models, and improving the system computing performance and resource utilization.

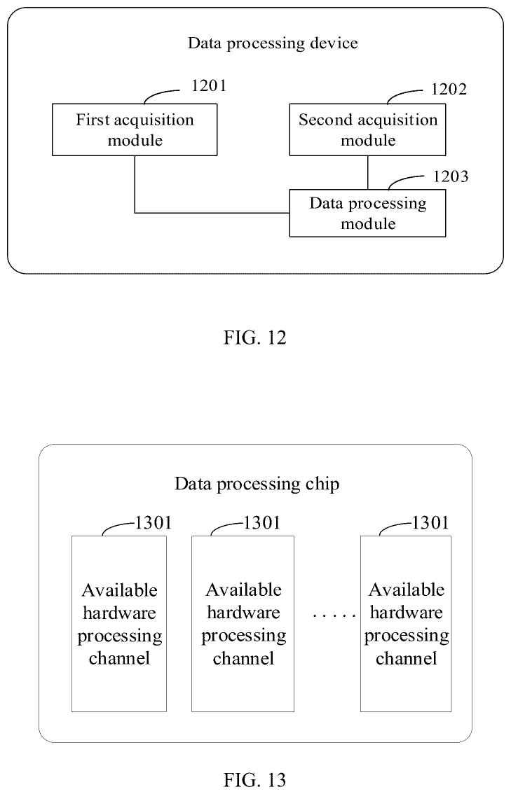

The present disclosure also provides a data processing device. In one embodiment, as shown in FIG. 12, which is a schematic structural diagram of a data processing device according to the present disclosure, the device at least includes:
a first acquisition module 1201, configured to acquire a first target data set, where: the first target data set is a set of first target data included in at least one first target data sub-object; the first target data in the first target data set at least includes all valid data of each first data sub-object in the first data object corresponding to the target data processing channel;
a second acquisition module 1202, configured to acquire each piece of second data included in a second data object corresponding to a target data processing channel; and
a data processing module 1203, configured to use the available hardware processing channels, according to the first position information corresponding to each piece of first target data, and the second position information corresponding to each piece of second data, to match each piece of first target data with each piece of second data, and perform data processing on the matched first target data and second data.

In one embodiment, the first position information may be used to indicate a corresponding position of the first target data in the first data object, and the second position information may be used to indicate a corresponding position of the second data in the second data object. Each valid data included in each first data sub-object may be located in one same first target data sub-object; and the number of the first target data sub-objects may be less than the number of the first data sub-objects.

In an optional embodiment, the device may further include a preprocessing module configured to form the first target data sub-objects based on preprocessing. The process of the preprocessing module forming the first target data sub-objects may include:
obtaining the first data object corresponding to the target data processing channel in the model; and
moving the valid data of the corresponding first data sub-objects in the first data object to the positions of the invalid data of other first data sub-objects to reduce the number of first data sub-objects included in the first data object.

The at least one first target data sub-object may include: the first data sub-object obtained after the movement is completed and at least including the valid data. The other first data sub-objects may include first data sub-objects other than the corresponding first data sub-objects in the first data object.

In an optional embodiment, the first data object may include a first data matrix having a plurality of pieces of data to be processed, and one first data sub-object may be a column in the first data matrix.

When the pre-processing module moves the valid data of the corresponding first data sub-objects in the first data object to the positions of the invalid data of the other first data sub-objects, it may be used to:
move the valid data of the corresponding columns in the first data matrix to the positions of the invalid data of other columns other than the corresponding columns in the first data matrix, to reduce the number of columns included in the first data matrix.

The at least one first target data sub-object may include: the first target columns obtained after the movement is completed and at least including the valid data. The data in one same column in the first data matrix may be located in one same first target column after the movement is completed.

In an optional embodiment, the data processing device may further include a real-time compression module, which is used to:
after acquiring each piece of second data included in the second data object corresponding to the target data processing channel, move the corresponding valid data of the corresponding second data sub-object in the second data object to the positions where the invalid data is located in the second data sub-object to remove at least part of the invalid data in the second data sub-object to obtain each second target data sub-object, to perform data processing on each piece of first target data and the second target data in each second target data sub-object.

Each second target data sub-object may be a corresponding second data sub-object including at least the valid data obtained by moving to remove the corresponding invalid data.

In an optional embodiment, the second data object may include a second data matrix having a plurality of pieces of data to be processed.

One second data sub-object may be a row in the second data matrix, and the second target data sub-object may include a row obtained by moving the valid data in the row included in the second data matrix to the positions where the invalid data is located in the row to remove at least part of the invalid data.

In an optional implementation, the data processing module 1203 may be used to:
determine the first target data and the second data that satisfy the first matching relationship according to the first position information corresponding to each piece of first target data and the second position information corresponding to each piece of second data; and
perform data processing on the first target data and the second data that satisfy the first matching relationship.

In an optional implementation, the first position information corresponding to the first target data may at least include the column index of the column to which the first target data belongs in the first data object; and the second position information corresponding to the second data may at least include the row index of the row to which the second data belongs in the second data object.

When determining the first target data and the second data that satisfy the first matching relationship according to the first position information corresponding to each piece of first target data and the second position information corresponding to each piece of second data, the data processing module 1203 may be used to:
determine the first target data and the second data whose column indexes corresponding to each piece of first target data and the row indexes corresponding to each piece of second data are the same as the first target data and the second data that satisfy the first matching relationship.

In an optional embodiment, the data processing module 1203, when processing the first target data and the second data satisfying the first matching relationship, may be used to:
perform multiplication operation on the first target data and the second data satisfying the first matching relationship to obtain the corresponding multiplication operation result; and
accumulate the multiplication operation results satisfying the second matching relationship among the different multiplication operation results to obtain the corresponding accumulation operation result.

In an optional embodiment, the number of the available hardware processing channels may be multiple, and each of the available hardware processing channels may include a first computing component and a second computing component connected to each other, where first computing components respectively included in the multiple available hardware processing channels are connected in series in sequence;

The data processing module 1203 may be further used to:
for each first target data sub-object, distribute the different first target data included in the first target data sub-object to different first computing components, and input the respective second data into the respective first computing components connected in series in sequence in a pipeline manner, such that each of the second data in the respective second data is moved in sequence between the respective first computing components connected in series until the last piece of second data in the first calculation component is moved to the tail of each first calculation component in series;
after the second data is input or the second data is moved once, in each first calculation component, according to the first position information corresponding to the currently-obtained first target data and the second position information corresponding to the currently-obtained second data, determine whether the currently-obtained first target data and the currently-obtained second data satisfy the first matching relationship, and, when the currently-obtained first target data and the currently-obtained second data satisfy the first matching relationship, perform multiplication operation on the first target data and the second data, and transmit the multiplication operation result to the connected second calculation component; and
in each second calculation component, accumulate the multiplication operation results that satisfy the second matching relationship between the obtained multiplication operation results to obtain the corresponding accumulation operation result.

The present disclosure also provides a data processing chip. In one embodiment, as shown in FIG. 13, which is a schematic structural diagram of a data processing chip according to the present disclosure, the data processing chip includes a plurality of available hardware processing channels 1301.

The plurality of available hardware processing channels 1301 may be used to:
obtain a first target data set, where: the first target data set is a set of first target data included in at least one first target data sub-object; the first target data in the first target data set at least includes all valid data of each first data sub-object in the first data object corresponding to a target data processing channel;
obtain each piece of second data included in a second data object corresponding to the target data processing channel; and
according to the first position information corresponding to each piece of first target data and the second position information corresponding to each piece of second data, match each piece of first target data with each piece of second data, and perform data processing on the matched first target data and second data.

The first position information may be used to indicate the corresponding positions of the first target data in the first data object, and the second position information may be used to indicate the corresponding positions of the second data in the second data object. Each valid data included in each first data sub-object may be located in one same first target data sub-object. The number of the first target data sub-objects may be less than the number of the first data sub-objects.

In an optional embodiment, each of the plurality of available hardware processing channels 1301 may include a first computing component and a second computing component connected to each other. First computing components respectively included in the plurality of available hardware processing channels 1301 may be connected in series in sequence;

Each of the first computing components may be used to: for each first target data sub-object, obtain the first target data distributed based on allocating the first target data included in the first target data sub-object among different first computing components, obtain the second data input based on inputting the second data in series in a pipeline manner, and determine whether the currently-obtained first target data is related to the second data according to the first position information corresponding to the currently-obtained first target data and the second position information corresponding to the currently-obtained second data; and, when the first matching relationship is satisfied, multiply the first target data and the second data such that the multiplication result is transmitted to the connected second computing component.

Each of the second computing components may be used to: accumulate multiplication results that satisfy the second matching relationship among the multiplication results corresponding to different first target data sub-objects to obtain the corresponding accumulation result.

For each first target data sub-object, each piece of second data in the second data input in a pipeline manner may be moved in sequence between the first computing components in series, and after the second data is input or the second data is moved once, each first computing component may be triggered to perform a multiplication operation until the last piece of second data in the second data is moved to the end part of the first computing components connected in series.

In an optional embodiment, the first computing component may include a multiplier, which is used to multiply the first target data and the second data that satisfy the first matching relationship, and transmit the multiplication result to the connected second computing component.

The second computing component may include an accumulator, which is used to accumulate the multiplication results that satisfy the second matching relationship among the multiplication results corresponding to different first target data sub-objects.

In an optional implementation, the first computing component may be a PE including a multiplier.

The data processing chip provided in the present disclosure corresponds to the data processing method disclosed in the above method embodiments, and is used to implement the data processing method disclosed in the above method embodiments based on the hardware structure of the chip and the functions of each component. For the more detailed functions of each component in the data processing chip, and the process of implementing data processing based on each component of the chip, references may be made to the description of each method embodiment above, which will not be repeated here.

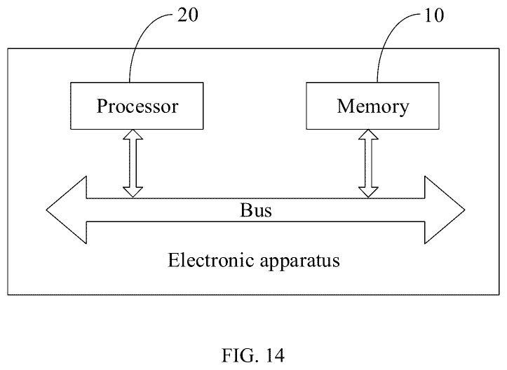

The present disclosure also provides an electronic apparatus. In one embodiment, as shown in FIG. 14, which is a schematic structural diagram of the electronic apparatus, the electronic apparatus at least includes:
a memory 10, configured to store a computer instruction set, where the computer instruction set may be implemented in the form of a computer program; and
a processor 20, configured to, by executing the computer instruction set, implement a data processing method provided by any method embodiment of the present disclosure.

The processor 20 may be a central processing unit (CPU), an application-specific integrated circuit (ASIC), a digital signal processor (DSP), an application-specific integrated circuit (ASIC), a field programmable gate array (FPGA), a neural network processor (NPU), a deep learning processor (DPU) or other programmable logic devices, etc.

The electronic apparatus may further include a display device and/or a display interface, or may be connected to an external display device.

Optionally, the electronic apparatus may further include a camera component, and/or may be connected to an external camera component.

The electronic apparatus may further include components such as a communication interface and a communication bus. The memory, the processor and the communication interface may communicate with each other through the communication bus.

The communication interface may be used for communication between the electronic apparatus and other devices. The communication bus may be a Peripheral Component Interconnect (PCI) bus or an Extended Industry Standard Architecture (EISA) bus, etc., and the communication bus may be divided into an address bus, a data bus, a control bus, etc.

The present disclosure also provides a readable storage medium on which a computer instruction set is stored, and the computer instruction set may be used to be called and executed by a processor to implement a data processing method as provided in any of the above method embodiments.

The present disclosure also provides a computer program product including a computer program/instruction, which implements a data processing method as provided in any of the above method embodiments when the computer program/instruction is executed by a processor.

It should be noted that each embodiment in the present disclosure is described in a progressive manner, and each embodiment focuses on the differences from other embodiments, and the same and similar parts between the embodiments can be referred to each other.

For the convenience of description, the above system or device is described separately by function into various modules or units. Of course, when implementing, the functions of each unit can be implemented in the same or multiple software and/or hardware.

Those skilled in the art can clearly understand that the present disclosure may be implemented by means of software plus the necessary general hardware platform. Based on this understanding, the technical solution of the present disclosure or the part that essentially contributes to the prior art may be embodied in the form of a software product, which can be stored in a storage medium, such as ROM/RAM, a hard disk, an optical disk, etc., including several instructions to enable a computer device (which can be a personal computer, a server, or a network device, etc.) to execute the methods described in any embodiment of the present disclosure or some parts of the embodiments.

Finally, it should be noted that in the present disclosure, relational terms such as first or second are only used to distinguish one entity or operation from another entity or operation, and do not necessarily require or imply any such actual relationship or order between these entities or operations. Further, the terms “include,” “comprise” or any other variant thereof are intended to cover non-exclusive inclusion, such that a process, method, article or device including a series of elements includes not only those elements, but also other elements not explicitly listed, or also includes elements inherent to such process, method, article or device. In the absence of further restrictions, the elements defined by the sentence “including one . . . ” do not exclude the existence of other identical elements in the process, method, article or device including the elements.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure is not limited to the embodiments shown herein, but conform to the widest scope consistent with the principles and novel features disclosed herein.

The above are only some embodiments of the present disclosure. It should be noted that for those of ordinary skill in the art, improvements and modifications can be made without departing from the principles of the present disclosure, and these improvements and modifications should also be regarded as being within the scope of the present disclosure.

What is claimed is:

1. A data processing chip comprising a plurality of hardware processing channels configured to:
obtain a first target data set formed by one or more pieces of first target data included in at least one first target data sub-object, the one or more pieces of first target data at least including all valid data of one or more first data sub-objects in a first data object corresponding to a target data processing channel;
obtain one or more pieces of second data included in a second data object corresponding to the target data processing channel;
perform matching on the one or more pieces of first target data and the one or more pieces of second data according to first position information corresponding to each of the one or more pieces of first target data and second position information corresponding to each of the one or more pieces of second data to obtain matched data, the matched data including one or more of the one or more pieces of first target data and one or more of the one or more pieces of second data that matching each other; and
perform data processing on the matched data;
wherein:
the first position information corresponding to one piece of first target data indicates a position of the one piece of first target data in the first data object, and the second position information corresponding to one piece of second data indicates a position of the one piece of second data in the second data object;
the valid data included in each of the one or more first data sub-objects is located in a same one of the at least one first target data sub-object; and
a number of the at least one first target data sub-object is less than a number of the one or more first data sub-objects.

2. The chip according to claim 1, wherein:
each of the plurality of hardware processing channels includes a first computing component and a second computing component connected to each other;
first computing components of the plurality of hardware processing channels are connected in series in sequence;
each first computing component is configured to:
for each first target data sub-object, obtain the first target data assigned to the first computing component, the one or more pieces of first target data included in the first target data sub-object being distributed to different one or more of the first computing components;
obtain the second data inputted to the first computing component, the one or more pieces of second data being inputted in a pipeline manner into the first computing components connected in series;
determine whether currently-obtained first target data and currently-obtained second data satisfy a first matching relationship based on the first position information corresponding to the currently-obtained first target data and the second position information corresponding to the currently-obtained second data;
in response to the currently-obtained first target data and the currently-obtained second data satisfying the first matching relationship, perform a multiplication operation on the currently-obtained first target data and the currently-obtained second data to obtain a multiplication operation result; and
transmit the multiplication operation result to the second computing component;
each second computing component is configured to accumulate one or more multiplication operation results, that satisfy a second matching relationship between each other, among the one or more multiplication operation results corresponding to the at least one first target data sub-object, to obtain an accumulation operation result; and
for each first target data sub-object, each piece of second data of the one or more pieces of second data, that are inputted in the pipeline manner, is moved in sequence among the first computing components connected in series, and each first computing component is triggered to perform the multiplication operation after the second data is input or after the second data is moved once, until the last piece of second data in the one or more pieces of second data moves to an end part of the first computing components that are connected in series.

3. The chip according to claim 2, wherein:
the first computing component includes a multiplier configured to perform the multiplication operation on the first target data and the second data that satisfy the first matching relationship, and transmit the multiplication result to the second computing component connected to the first computing component; and
the second computing component includes an accumulator configured to accumulate the one or more multiplication results that satisfy the second matching relationship.

4. A data processing method comprising:
obtaining a first target data set formed by one or more pieces of first target data included in at least one first target data sub-object, the one or more pieces of first target data at least including all valid data of one or more first data sub-objects in a first data object corresponding to a target data processing channel;
obtaining one or more pieces of second data included in a second data object corresponding to the target data processing channel;
performing matching on the one or more pieces of first target data and the one or more pieces of second data according to first position information corresponding to each of the one or more pieces of first target data and second position information corresponding to each of the one or more pieces of second data to obtain matched data, the matched data including one or more of the one or more pieces of first target data and one or more of the one or more pieces of second data that matching each other; and
performing data processing on the matched data;
wherein:
the first position information corresponding to one piece of first target data indicates a position of the one piece of first target data in the first data object, and the second position information corresponding to one piece of second data indicates a position of the one piece of second data in the second data object;
the valid data included in each of the one or more first data sub-objects is located in a same one of the at least one first target data sub-object; and
a number of the at least one first target data sub-object is less than a number of the one or more first data sub-objects.

5. The method according to claim 4, wherein:
the at least one first target data sub-object is formed by:
obtaining the first data object corresponding to the target data processing channel in a model; and
moving valid data of one first data sub-object in the first data object to one or more positions of invalid data of another first data sub-object to reduce a number of the one or more first data sub-objects included in the first data object; and
the at least one first target data sub-object includes the first data sub-object obtained after data moving and at least including the valid data, and the other first data sub-object is a first data sub-object other than the first data sub-object obtained after data moving.

6. The method according to claim 5, wherein:
the first data object includes a first data matrix having a plurality of pieces of data to be processed, and the one first data sub-object is a column in the first data matrix;
moving the valid data of the one first data sub-object includes:
moving valid data of a corresponding column in the first data matrix to one or more positions of invalid data of other column, other than the corresponding column, in the first data matrix, to reduce a number of columns in the first data matrix;
the at least one first target data sub-object includes one or more first target columns at least including the valid data after data moving is completed, and data in a same column in the first data matrix is in a same one of the one or more first target columns after data moving is completed.

7. The method according to claim 4, further comprising, after obtaining the one or more pieces of second data:
moving valid data of a corresponding second data sub-object in the second data object to the position where invalid data in the corresponding second data sub-object is located to eliminate at least part of the invalid data in the corresponding second data sub-object, to obtain one or more second target data sub-objects, the each piece of first target data and the second target data in each second target data sub-object being subject to data processing;
wherein each second target data sub-object is a second data sub-object that includes at least valid data and is obtained after the corresponding invalid data is eliminated by data moving.

8. The method according to claim 7, wherein:
the second data object includes a second data matrix having a plurality of pieces of data to be processed, and one second data sub-object is a row in the second data matrix; and
one second target data sub-object includes a row obtained by moving valid data in the row included in the second data matrix to one or more positions of invalid data in the corresponding row to eliminate at least part of the invalid data.

9. The method according to claim 4, wherein performing matching on the one or more pieces of first target data and the one or more pieces of second data includes:
determining the first target data and the second data that satisfy a first matching relationship according to the first position information corresponding to each of the one or more pieces of first target data and the second position information corresponding to each of the one or more pieces of second data.

10. The method according to claim 9, wherein:
the first position information corresponding to one piece of first target data at least includes a column index of a column to which the one piece of first target data belongs in the first data object;
the second position information corresponding to one piece of second data at least includes a row index of a row to which the one piece of second data belongs in the second data object; and
determining the first target data and the second data that satisfy the first matching relationship includes determining one piece of first target data and one piece of second data that have a same column index as the first target data and the second data that satisfy the first matching relationship.

11. The method according to claim 9, wherein performing data processing on the matched data includes:
performing a multiplication operation on the first target data and the second data that satisfy the first matching relationship to obtain one or more different multiplication operation results; and
accumulating one or more multiplication operation results, that satisfy a second matching relationship, in the one or more different multiplication operation results to obtain an accumulation operation result.

12. The method according to claim 4, wherein:
matching and data processing are performed using a plurality of hardware processing channels each including a first computing component and a second computing component connected to each other;
first computing components of the plurality of hardware processing channels are connected in series in sequence; and
performing matching and data processing includes:
for each first target data sub-object, distributing the one or more pieces of first target data included in the first target data sub-object to different one or more of the first computing components, and inputting the one or more pieces of second data in a pipeline manner into the first computing components connected in series, such that each piece of second data of the one or more pieces of second data is moved in sequence among the first computing components connected in series, until the last piece of second data in the one or more pieces of second data moves to an end part of the first computing components that are connected in series;
after the second data is input or after the second data is moved once, in each first computing component, determine whether currently-obtained first target data and currently-obtained second data satisfy a first matching relationship based on the first position information corresponding to the currently-obtained first target data and the second position information corresponding to the currently-obtained second data, and, in response to the currently-obtained first target data and the currently-obtained second data satisfying the first matching relationship, performing a multiplication operation on the currently-obtained first target data and the currently-obtained second data to obtain a multiplication operation result, and transmitting the multiplication operation result to the second computing component; and
accumulating, in each second computing component, one or more multiplication operation results, that satisfy a second matching relationship between each other, among the one or more multiplication operation results corresponding to the at least one first target data sub-object, to obtain an accumulation operation result.

13. A non-transitory computer-readable storage medium storing instructions that, when executed by a processor, cause the processor to:
obtain a first target data set formed by one or more pieces of first target data included in at least one first target data sub-object, the one or more pieces of first target data at least including all valid data of one or more first data sub-objects in a first data object corresponding to a target data processing channel;
obtain one or more pieces of second data included in a second data object corresponding to the target data processing channel;
perform matching on the one or more pieces of first target data and the one or more pieces of second data according to first position information corresponding to each of the one or more pieces of first target data and second position information corresponding to each of the one or more pieces of second data to obtain matched data, the matched data including one or more of the one or more pieces of first target data and one or more of the one or more pieces of second data that matching each other; and
perform data processing on the matched data;
wherein:
the first position information corresponding to one piece of first target data indicates a position of the one piece of first target data in the first data object, and the second position information corresponding to one piece of second data indicates a position of the one piece of second data in the second data object;
the valid data included in each of the one or more first data sub-objects is located in a same one of the at least one first target data sub-object; and
a number of the at least one first target data sub-object is less than a number of the one or more first data sub-objects.

14. The storage medium according to claim 13, wherein:
the at least one first target data sub-object is formed by:
obtaining the first data object corresponding to the target data processing channel in a model; and
moving valid data of one first data sub-object in the first data object to one or more positions of invalid data of another first data sub-object to reduce a number of the one or more first data sub-objects included in the first data object; and
the at least one first target data sub-object includes the first data sub-object obtained after data moving and at least including the valid data, and the other first data sub-object is a first data sub-object other than the first data sub-object obtained after data moving.

15. The storage medium according to claim 14, wherein:
the first data object includes a first data matrix having a plurality of pieces of data to be processed, and the one first data sub-object is a column in the first data matrix;
the instructions, when executed by the processor, further cause the processor to, when moving the valid data of the one first data sub-object:
move valid data of a corresponding column in the first data matrix to one or more positions of invalid data of other column, other than the corresponding column, in the first data matrix, to reduce a number of columns in the first data matrix;
the at least one first target data sub-object includes one or more first target columns at least including the valid data after data moving is completed, and data in a same column in the first data matrix is in a same one of the one or more first target columns after data moving is completed.

16. The storage medium according to claim 13, wherein the instructions, when executed by the processor, further cause the processor to, after obtaining the one or more pieces of second data:
move valid data of a corresponding second data sub-object in the second data object to the position where invalid data in the corresponding second data sub-object is located to eliminate at least part of the invalid data in the corresponding second data sub-object, to obtain one or more second target data sub-objects, the each piece of first target data and the second target data in each second target data sub-object being subject to data processing;
wherein each second target data sub-object is a second data sub-object that includes at least valid data and is obtained after the corresponding invalid data is eliminated by data moving.

17. The storage medium according to claim 16, wherein:
the second data object includes a second data matrix having a plurality of pieces of data to be processed, and one second data sub-object is a row in the second data matrix; and
one second target data sub-object includes a row obtained by moving valid data in the row included in the second data matrix to one or more positions of invalid data in the corresponding row to eliminate at least part of the invalid data.

18. The storage medium according to claim 13, wherein the instructions, when executed by the processor, further cause the processor to, when performing matching on the one or more pieces of first target data and the one or more pieces of second data:
determine the first target data and the second data that satisfy a first matching relationship according to the first position information corresponding to each of the one or more pieces of first target data and the second position information corresponding to each of the one or more pieces of second data.

19. The storage medium according to claim 18, wherein:
the first position information corresponding to one piece of first target data at least includes a column index of a column to which the one piece of first target data belongs in the first data object;
the second position information corresponding to one piece of second data at least includes a row index of a row to which the one piece of second data belongs in the second data object; and
the instructions, when executed by the processor, further cause the processor to, when determining the first target data and the second data that satisfy the first matching relationship, determine one piece of first target data and one piece of second data that have a same column index as the first target data and the second data that satisfy the first matching relationship.

20. The storage medium according to claim 18, wherein the instructions, when executed by the processor, further cause the processor to, when performing data processing on the matched data:
perform a multiplication operation on the first target data and the second data that satisfy the first matching relationship to obtain one or more different multiplication operation results; and
accumulate one or more multiplication operation results, that satisfy a second matching relationship, in the one or more different multiplication operation results to obtain an accumulation operation result.
